(19) United States
(12) Patent Application Publication
(10) Pub. No.: US 2025/0158523 A1
(43) Pub. Date: May 15, 2025

(54) CONTROLLER FOR A SWITCHING CONVERTER

(71) Applicant: Renesas Design (UK) Limited, Bourne End (GB)

(72) Inventors: Guillaume DE CREMOUX, Edinburgh (GB); Codrin HORA, Edinburgh (GB)

(73) Assignee: Renesas Design (UK) Limited, Bourne End (GB)

(21) Appl. No.: 18/819,185

(22) Filed: Aug. 29, 2024

Related U.S. Application Data
(60) Provisional application No. 63/597,874, filed on Nov. 10, 2023.

(51) Int. Cl. H02M 3/157; H02M 1/00

(52) U.S. Cl. CPC H02M 3/157; H02M 1/0009

(57) ABSTRACT

A controller for a switching converter. The switching converter is configured to receive an input voltage and to generate an output voltage. The switching converter includes one or more power switches and one or more energy storage elements. The one or more energy storage elements includes a first energy storage element. The controller is configured to control the switching converter while operating in a first control mode during a first state, and control the switching converter while operating in a hysteretic control mode during a second state.

### CROSS-REFERENCE TO RELATED APPLICATION

This application claims the benefit of U.S. Provisional Application No. 63/597,874 filed on Nov. 10, 2023. The entire contents of U.S. Provisional Application No. 63/597,874 are incorporated herein by reference.

### FIELD

The present disclosure relates to a controller for a switching converter.

### BACKGROUND

FIG. 1 is a schematic of a digital buck converter 100 with analog to digital converters (ADC) 102, 104, 106 and a controller 108. The buck converter 100 comprises switches 110, 112, an inductor 114 and a capacitor 116. During operation, the switching converter receives an input voltage VIN and generates an output voltage VOUT. A buck converter is a DC/DC converter.

While the power stage and passive components (the inductor 114 and the capacitor 116) remain the same as for an analog buck converter, the ADC 102 converts the output voltage VOUT into a digital number. Note that the power switches 110, 112 are also the same for analog/digital converters.

Optionally, the inductor current IL of the inductor 114, and the input voltage VIN can also be converted from analog to digital, depending on the digital control method.

The switching frequency (FSW) of the buck converter 100, for example 2 MHz. FSW is equal to 1/TSW, where TSW is the switching period of the buck converter 100. FSW is the frequency of the power stage.

The processing frequency of the digital controller 108 (FS), for example about 100 MHz. FS is equal to 1/TS, where TS is the processing period of the controller 108. FS can also optionally be the sampling frequency of ADC 102.

### SUMMARY

It is desirable to provide an improved controller for a switching converter, such as a digital buck converter.

According to a first aspect of the disclosure there is provided a controller for a switching converter, the switching converter being configured to receive an input voltage and to generate an output voltage, and comprising one or more power switches and one or more energy storage elements, the one or more energy storage elements comprising a first energy storage element, the controller being configured to control the switching converter whilst operating in a first control mode during a first state, and control the switching converter whilst operating in a hysteretic control mode during a second state.

Optionally, the controller is a digital controller.

Optionally, the switching converter is a buck converter, a boost converter, a buck-boost converter or a hybrid converter.

Optionally, the first energy storage element is an inductor.

Optionally, the one or more power switches comprises a first power switch and a second power switch.

Optionally, the first control mode is a linear control mode.

Optionally, the linear control mode is a current control mode.

Optionally, the controller is configured to receive a digitized output voltage signal, the digitized output voltage signal being a digital representation of the output voltage of the switching converter.

Optionally, the digitized output voltage signal is received from a first analog to digital converter that is configured to receive the output voltage and to digitize the output voltage to generate the digitized output voltage signal.

Optionally, the controller comprises a first control circuit, the first control circuit being activated during the first state to provide the first control mode.

Optionally, the first control circuit is configured to generate a digital target current signal using the digitized output voltage signal.

Optionally, the first control circuit comprises a first voltage error generation circuit configured to use the digitized output voltage signal and a digital voltage reference signal to generate a digital error signal, and a digital target current signal generation circuit configured to convert the digital error signal into the digital target current signal.

Optionally, the digital target current signal generation circuit comprises a proportional-integral circuit or a proportional-integral-derivative circuit.

Optionally, the first voltage error generation circuit is configured to generate the digital error signal by subtracting the digitized output voltage signal from the digital voltage reference signal.

Optionally, the first control circuit comprises a first current error generation circuit configured to receive the digital target current signal, and receive a digitized current signal, the digitized current signal being a digital representation of a current flow through the first energy storage element, and generate a digital current error signal.

Optionally, the digitized current signal is received from a digitized current generation circuit.

Optionally, the digitized current generation circuit comprises a second analog to digital converter that is configured to sense the current flow through the first energy storage element and to digitize the sensed current flow to generate the digitized current signal.

Optionally, the digitized current generation circuit comprises a current synthesizer.

Optionally, the first control circuit comprises a modulator configured to generate a first mode control signal using the digital current error signal, and the controller comprises a logic and gate driver circuit configured to receive the first mode control signal during the first state and to generate a gate driving signal for each of the one or more power switches using the first mode control signal.

Optionally, the controller comprises a hysteretic control circuit, the hysteretic control circuit being activated during the second state to provide the hysteretic control mode.

Optionally, the hysteretic control circuit is configured to generate an up signal for charging the first energy storage element during the second state when the digitized output voltage signal falls below a first threshold voltage, and generate a down signal for discharging the first energy storage element during the second state when the digitized output signal rises above a second threshold voltage.

Optionally, the controller comprises a logic and gate driver circuit configured to receive the up signal and the down signal during the second state and to generate a gate driving signal for each of the one or more power switches using the up and down signals.

Optionally, the controller is configured to switch from the first control mode to the hysteretic control mode in response to a load transient.

Optionally, the controller is configured to detect the load transient.

Optionally, the controller is configured to receive a digitized output voltage signal, the digitized output voltage signal being a digital representation of the output voltage of the switching converter.

Optionally, the controller comprises a first control circuit, the first control circuit being activated during the first state to provide the first control mode.

Optionally, the first control circuit is configured to generate a digital target current signal using the digitized output voltage signal.

Optionally, the first control circuit comprises a first current error generation circuit configured to receive the digital target current signal, and receive a digitized current signal, the digitized current signal being a digital representation of a current flow through the first energy storage element, and generate a digital current error signal.

Optionally, the first control circuit comprises a modulator configured to generate a first mode control signal using the digital current error signal, and the controller comprises a logic and gate driver circuit configured to receive the first mode control signal during the first state and to generate a gate driving signal for each of the one or more power switches using the first mode control signal.

Optionally, the controller comprises a hysteretic control circuit, the hysteretic control circuit being activated during the second state to provide the hysteretic control mode.

Optionally, the hysteretic control circuit is configured to generate an up signal for charging the first energy storage element during the second state when the digitized output voltage signal falls below a first threshold voltage, and generate a down signal for discharging the first energy storage element during the second state when the digitized output signal rises above a second threshold voltage.

Optionally, the logic and gate driver circuit configured to receive the up signal and the down signal during the second state and to generate the gate driving signal for each of the one or more power switches using the up and down signals.

Optionally, the controller comprises one or more digital gates configured to receive the first mode control signal, the up signal and the down signal, provide the first mode control signal to the logic and gate drivers during the first state, and provide the up signal and the down signal to the logic and gate drivers during the second state.

Optionally, the one or more digital gates comprises an AND gate comprising a first inverted input for receiving the down signal, and a first non-inverting input for receiving the first mode control signal, and an OR gate comprising a first input for receiving the up signal, a second input for receiving an output of the AND gate, and an output for providing the first mode control signal to the logic and gate drivers during the first state and for providing the up signal and the down signal to the logic and gate drivers during the second state.

Optionally, the controller is configured to sample the output voltage to acquire a first sampled voltage at a first time step and a second sampled voltage at a second time step, determine a sampled voltage difference by subtracting the second sampled voltage from the first sampled voltage, generate an up signal for charging the first energy storage element during the second state when the sampled voltage difference is less than a first voltage difference threshold value, and generate a down signal for discharging the first energy storage element during the second state when the sampled voltage difference is greater than a second voltage difference threshold value.

Optionally, the first sampled voltage is acquired during a first switching period of the switching converter and the second sampled voltage is acquired during a second switching period of the switching converter.

Optionally, the second time step is one switching period of the switching converter after the first time step.

Optionally, the controller is configured to periodically sample the output voltage to acquire n sampled voltages over n time steps, where n is an integer, repeatedly determine an nth sampled voltage difference by subtracting an (n-m)th sampled voltage from the nth sampled voltage where m is an integer, generate an up signal for charging the first energy storage element during the second state when the nth sampled voltage difference is less than a first voltage difference threshold value, and generate a down signal for discharging the first energy storage element during the second state when the nth sampled voltage difference is greater than a second voltage difference threshold value.

Optionally, the (n-m)th sampled voltage is acquired during a first switching period of the switching converter and the nth sampled voltage is acquired during a second period of the switching converter.

Optionally, the nth time step is one switching period of the switching converter after (n-m)th time step.

Optionally, m is equal to 8.

Optionally, the controller is configured to control the switching converter whilst operating in an intermediate control mode during a third state.

Optionally, the controller is configured to switch from the first control mode to the hysteretic control mode in response to a load transient.

Optionally, the controller is configured to switch to the intermediate control mode after the hysteretic control mode and before switching to the first control mode.

Optionally, the controller is configured to receive a digitized output voltage signal, the digitized output voltage signal being a digital representation of the output voltage of the switching converter.

Optionally, the controller comprises a first control circuit, the first control circuit being activated during the first state to provide the first control mode.

Optionally, the first control circuit is configured to generate a digital target current signal using the digitized output voltage signal.

Optionally, the first control circuit comprises a first voltage error generation circuit configured to use the digitized output voltage signal and a digital voltage reference signal to generate a digital error signal, and a digital target current signal generation circuit configured to convert the digital error signal into the digital target current signal.

Optionally, the controller is configured to correct the digital target current signal during the intermediate control mode.

Optionally, the digital target current signal generation circuit comprises a proportional-integral circuit or a proportional-integral-derivative circuit.

Optionally, the first control circuit comprises a first current error generation circuit configured to receive the digital target current signal, and receive a digitized current signal, the digitized current signal being a digital representation of a current flow through the first energy storage element, and generate a digital current error signal.

Optionally, the proportional-integral circuit comprises a first amplifier, a second amplifier, a first summing circuit, a second summing circuit, and a register.

Optionally, the first and second amplifiers are configured to receive the digital error signal, the first amplifier comprises an output coupled to a first input of the first summing circuit, the second amplifier comprises an output coupled to a first input of the second summing circuit, an output of the second summing circuit being coupled to a second input of the first summing circuit and an input of the register, and the register comprises an output coupled to a second input of the second summing circuit.

Optionally, the controller is configured to update the register based on the digitized current signal, the gain of the first amplifier, the digitized output voltage signal and the digital voltage reference signal, thereby correcting the digital target current signal during the intermediate control mode.

Optionally, the digital target current signal generation circuit comprises one or more registers.

Optionally, the controller is configured to update at least one of the one or more registers based on the digitized current signal, thereby correcting the digital target current signal during the intermediate control mode.

Optionally, the controller is configured to resynchronize a clock cycle of the switching converter to a carrier clock after switching from the intermediate control mode.

According to a second aspect of the disclosure there is provided a method of controlling a switching converter using a controller, the switching converter being configured to receive an input voltage and to generate an output voltage, and comprising one or more power switches and one or more energy storage elements, the one or more energy storage elements comprising a first energy storage element, the method comprising controlling the switching converter whilst operating in a first control mode during a first state, and controlling the switching converter whilst operating in a hysteretic control mode during a second state.

It will be appreciated that the method of the second aspect may include features set out in the first aspect and can incorporate other features as described herein.

### BRIEF DESCRIPTION OF THE DRAWINGS

This disclosure is described in further detail below by way of example and with reference to the accompanying drawings, in which:

FIG. 1 is a schematic of a digital buck converter;

FIG. 2A is a schematic of the buck converter where the controller is implemented as a current mode linear controller;

FIG. 2B is a schematic of the buck converter where the controller is implemented as an analog hysteretic “Bang-Bang” type controller;

FIG. 3A is a schematic of a controller for a switching converter in accordance with a first embodiment of the present disclosure;

FIG. 3B is a timing graph showing the operation of the controller and switching converter for a practical implementation of the present disclosure;

FIG. 4A is a schematic of the controller in accordance with a second embodiment of the present disclosure

FIG. 4B is a schematic of the controller in accordance with a third embodiment of the present disclosure′

FIG. 4C is a schematic of the controller in accordance with a fourth embodiment of the present disclosure;

FIG. 5A is a timing graph showing waveforms relating to a practical implementation of the controller and switching converter of FIG. 4C;

FIG. 5B is a further timing graph showing waveforms relating to a practical implementation of the controller and the switching converter of FIG. 4C;

FIG. 5C is a further timing graph showing the waveforms as presented in FIG. 5C over a specific time period;

FIG. 6 is a timing graph relating to a practical implementation of the present embodiment of the controller;

FIG. 7A is a timing graph relating to a practical implementation of the present embodiment of the controller;

FIG. 7B is a flow chart showing the process undertaken by the specific embodiment of the controller as described in relation to FIG. 7A;

FIG. 8A shows simulation results of a practical implementation of the controller;

FIG. 8B shows simulation results of a practical implementation of the controller showing random hysteretic events with clock sliding recovery;

FIG. 8C shows simulation results of the practical implementation of the controller;

FIG. 8D shows simulation results of a practical implementation of the controller compared with a system that only provides linear control; and

FIG. 9 is a schematic of the controller in accordance with a fifth embodiment of the present disclosure.

### DETAILED DESCRIPTION

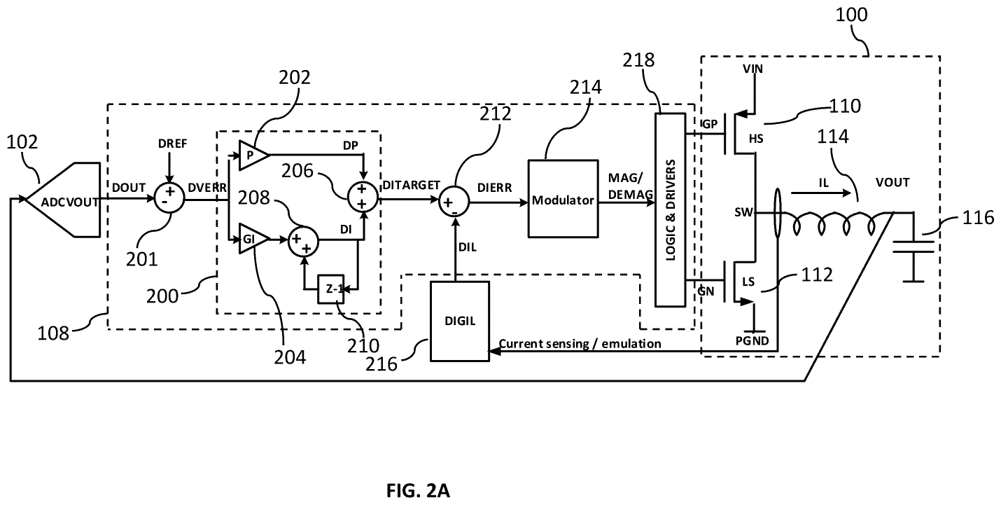

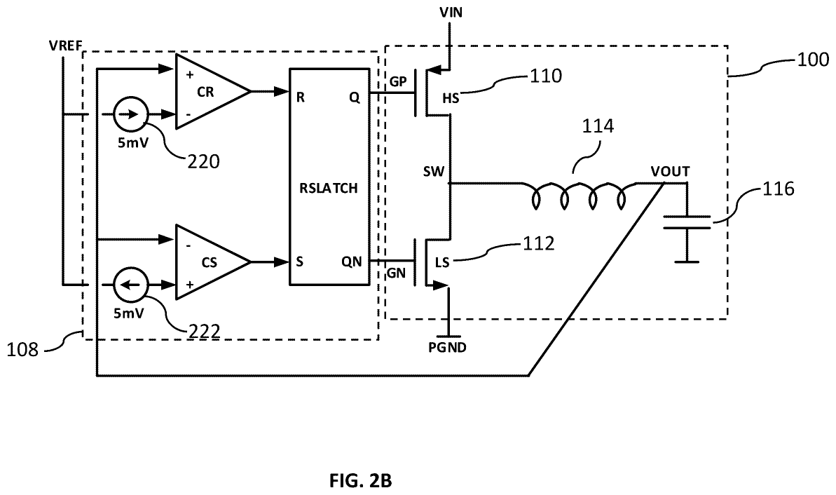

FIG. 2A is a schematic of the buck converter 100 where the controller 108 is implemented as a current mode linear controller. The controller 108 is a digital controller.

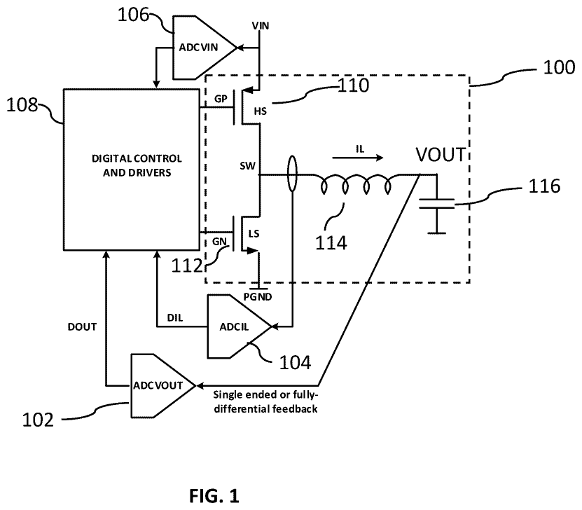

Operation of the circuit of FIG. 2A is as follows:
The output voltage VOUT is digitized through the ADC 102 to give a digitized output voltage signal DOUT. The digitized output voltage signal DOUT is compared to a digital reference voltage DREF that corresponds to the target voltage for the output voltage VOUT. Both numbers DOUT, DREF can be e.g. 8-bit bus, where the digital code [0; 255] corresponds to the analog range [0.50V; 1.50V].
A digital error voltage signal DVERR is equal to DREF-DOUT, which is provided into a linear digital loop control circuit 200 to convert this digitized error voltage DVERR into a digital target current DITARGET=DP+DI, which is a digital number that is the target to set for the analog inductor current IL to restore the output voltage VOUT. The digital error voltage signal DVERR is provided by an error circuit 201.
The linear digital loop control circuit 200 may be implemented using a proportional integral derivative. In the present example, the control circuit 200 comprises a P path comprising an amplifier 202 having a gain P and providing an output DP, and an I path having an amplifier 204 having a gain I and providing an output DI. Optionally, there may be provided a D path. The circuit 200 further comprises summing circuits 206, 208 and a register 210.
The digital target current DITARGET may be coded on more bits, e.g. 16 bits, as well as the following signals. The digital target current DITARGET is compared to the digitized inductor current DIL by a difference circuit 212, and the difference DIERR enters a modulator 214 which adjusts the duty-cycle MAG/DEMAG such that the analog inductor current IL matches its digital counterpart DITARGET, on average. A logic and driver circuit 218 provides the gate driver signals GP, GN to the transistor gates.
A digital current generation circuit 216 may be the ADC 104 as shown in FIG. 1 or may be a “synthesizer”, so it can reproduce, in digital, the inductor current IL-behavior depending on the input voltage VIN, the output voltage VOUT, the duty-cycle and possibly other parameters.
The digital modulator 214 may be a peak, a valley, or an average modulator. The modulator 214 ensures that the analog current IL follows the digital target current DITARGET. This is why the control method provided by the controller 108 in FIG. 2A is referred to as “current mode”—the regulation commands the current DITARGET, and the modulator ensures that the average digital target current is equal to the average digital inductor current, which may be denoted as follows:

$$< DITARGET >= < DIL > \qquad ( 1 )$$

A variable enclosed by “< >” is used to denote an average of the variable. For example, <x> denotes the average of the variable x.

It will be appreciated that equation (1) relates to a modulator being configured to match DITARGET to the average DIL. However, in further embodiments, the modulator may be a peak or a valley modulator, in accordance with the understanding of the skilled person.

Constant frequency linear modulations, such as current mode provided both advantages and disadvantages with examples being provided below:

### Advantages:

Constant frequency for EMI (Electro-Magnetic-Interferences)
Easy to design and calculate the stability parameters

### Disadvantages:

The constant frequency makes it inherently slower: if VOUT drops, action can be taken only on the next clock edge inside the modulator.
In the PID, the P-path gain must be limited to 100 A/V (I-path is slow and is used only for fine tuning). The reason is as follows: for COUT˜9 uF, the 0 dB gain-crossing frequency is Fu=Gm/(2PI.COUT) which, with these values, is ˜2 MHz. For a DCDC converter switching at 4 MHz, it corresponds to the Nyquist frequency Fnyquist. If Fu>Fnyquist, or is close to equal, unpredictable instability can occur. So if P=100, a 6 A load means a spontaneous 60 mV drop on VOUT. It is desirable to have a voltage drop of around 40 mV for practical applications.

FIG. 2B is a schematic of the buck converter 100 where the controller 108 is implemented as an analog hysteretic “Bang-Bang” type controller. Digital hysteretic controllers are also known. Hysteretic regulators (also known as “ripple” regulators) offer superior performance when compared with linear control modes, such as that of FIG. 2A.

The controller 108 comprises comparators CS, CR, a logic circuit RSLATCH and voltage sources 220, 222.

When VOUT drops below VREF-5 mV, the comparator CS set RSLATCH to turn on HS and off LS: we recharge VOUT. When VOUT exceeds VREF+5 mV, the comparator CR re-set RSLATCH to turn off HS and on LS: we stop re-charging VOUT, which will go down due to the load. So, the hysteretic controller sets the ripple at +/−5 mV (hence the naming “ripple regulator”).

Hysteretic controllers have the following advantages/disadvantages:

### Advantages:

Spontaneous reaction, so improved performances over linear control mode regulators.

### Disadvantages:

The frequency is variable: not only in steady-state (constant load, VIN and VOUT) but also when the load varies. Methods for regulating the frequency are common, using FLL/PLL to regulate the +/−5 mV above to different values, but they are slow to settle and thus the frequency jumps always occur when there is a transient load/line.

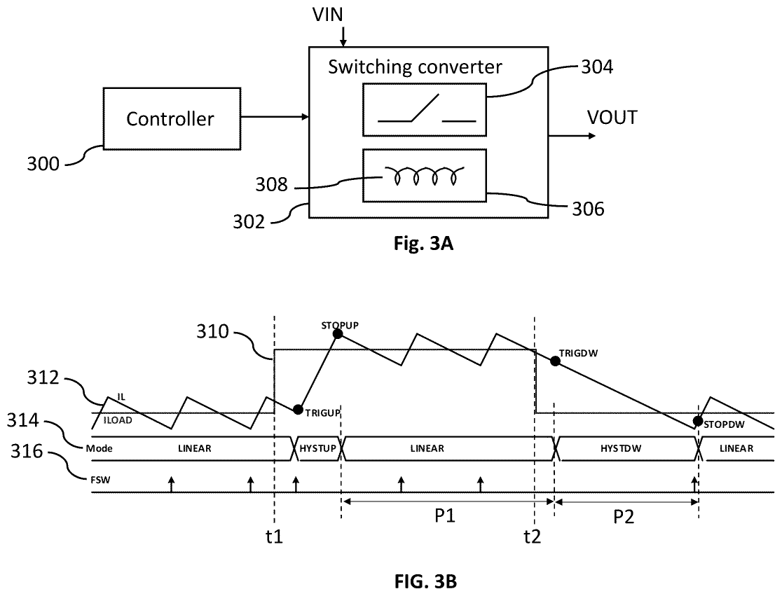

FIG. 3A is a schematic of a controller 300 for a switching converter 302 in accordance with a first embodiment of the present disclosure.

During operation, the switching converter 302 receives an input voltage Vin and generates an output voltage Vout. The switching converter 302 comprises one or more power switches 304 and one or more energy storage elements comprising a first energy storage element 306.

The controller 300 is configured to control the switching converter 302 whilst operating in a first control mode during a first state and control the switching converter whilst operating in a hysteretic control mode during a second state.

The controller 300 may be configured to switch from the first control mode to the hysteretic control mode in response to a load transient. The controller 300 may be configured to detect the load transient.

The controller 300 may be a digital controller. The switching converter 302 may, for example, be a buck converter, a boost converter, a buck-boost converter or a hybrid converter. It will be appreciated that the switching converter 302 may be a single phase converter, such as a buck converter, a boost converter or a buck-boost converter; or may be a multi-phase converter such as a hybrid converter.

It will be appreciated that a hybrid converter may have two or more energy storage elements. The two or more energy storage elements of a hybrid converter may comprise inductors and/or capacitors.

The first energy storage element 306 may be an inductor 308. The first control mode is a linear control mode, such as a current control mode. “Linear” describes the controller being describable mathematically and its behaviour being predictable.

The controller 300 enables the control scheme to be switched during operation of the switching converter 302 thereby providing the benefits of the hysteretic control mode when desirable.

Specifically, it is desirable to combine the benefits of hysteretic control mode (such as the fast reaction speed) with the benefits of the linear control mode (such as good EMI performance and constant frequency). For example, it is desirable for there to be an immediate reaction of the controller 300 in response to a transient load, and this is provided by the controller 300 where the immediate reaction is provided by switching to the hysteretic control mode, with the switching converter 300 returning to the linear mode in a seamless way. It is also desirable for the impact of the sporadic hysteretic events to be minor on the overall operation of the switching converter 302.

FIG. 3B is a timing graph showing the operation of the controller 300 and switching converter 302 for a practical implementation of the present disclosure. There is shown a load current ILOAD (a trace 310), an inductor current IL (a trace 312), the control mode (labelled 314), and a charging pulse (a trace 316).

The load current ILOAD is the current taken by an external circuit: it is a current source pulling down the output voltage VOUT. The switching converter 302 will adjust the current IL to match the load current ILOAD, in average, to regulate the output voltage VOUT. Load transients describe sudden variations in the load current, which occur at times t1, t2.

The inductor current IL is the current flowing through the inductor 308 of the switching converter 302 during operation.

The control mode shows the present control mode at various stages of operation. “LINEAR” denotes the switching converter 302 operating in the linear control mode. “HYSTUP” and “HYSTDW” denoted hysteretic control modes for rising and falling load transients, respectively. A time period P1 shows an example of the “first state” as described previously, and a time period P2 shows an example of the “second state” as described previously. It will be appreciated that the cycle of first and second states can repeat during operation as load transients occur.

The charging pulse shows the control of the switches 304, with an upward facing arrow denoting when the switches 304 are configured to permit charging of the inductor 308. It can be observed that during the linear mode, the charging and discharging of the inductor 308 occurs at a constant frequency FSW, whereas during the hysteretic mode the frequency is subject to variation.

In summary, the mode is swapped from LINEAR (PID regulation in control) to sporadic states named HYSTUP/HYSTDW to allow the load current IL to ramp up continuously (which means that the system is no longer operating with a constant frequency). When there is no need for continuously ramping the inductor current IL anymore, the regulation returns to the LINEAR mode.

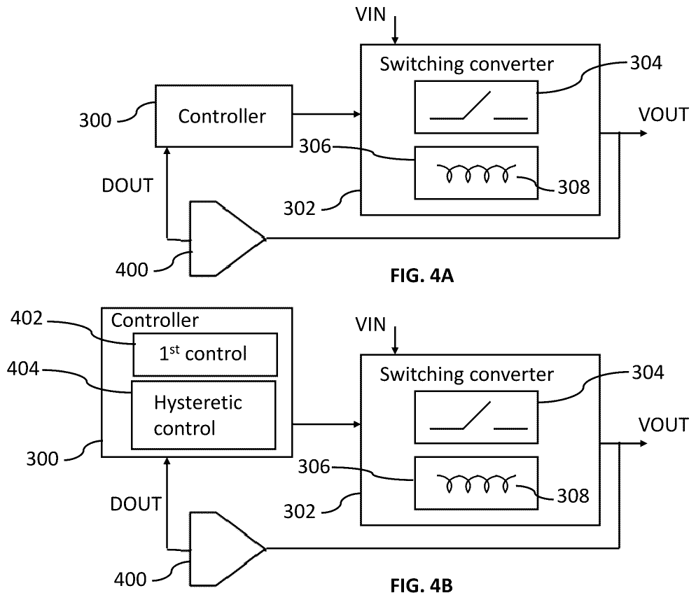

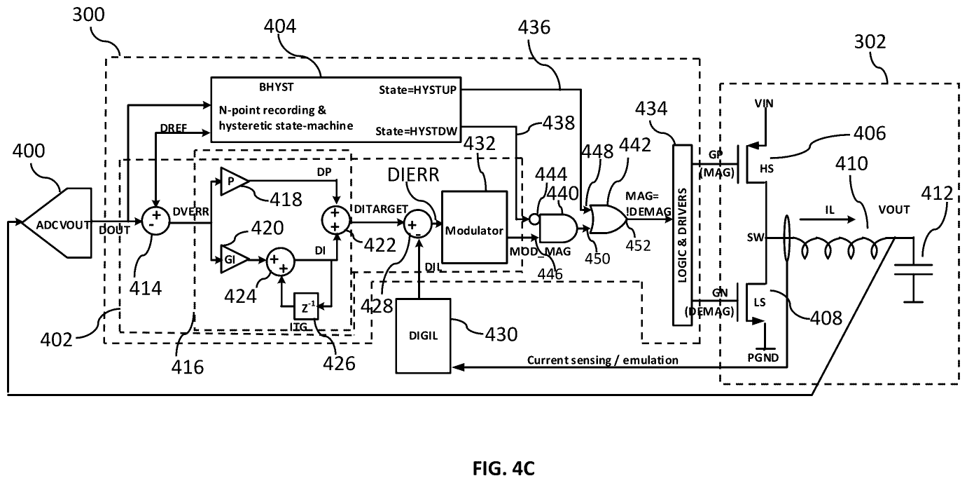

FIG. 4A is a schematic of the controller 300 in accordance with a second embodiment of the present disclosure. In the present embodiment, the controller 300 is configured to receive a digitized output voltage signal DOUT, which is a digital representation of the output voltage VOUT of the switching converter 302. The digitized output voltage signal DOUT may be received from an analog to digital converter (ADC) 400 that is configured to receive and then digitize the output voltage VOUT to generate the digitized output voltage signal DOUT.

FIG. 4B is a schematic of the controller 300 in accordance with a third embodiment of the present disclosure, showing a specific implementation of the controller 300.

In the present embodiment, the controller 300 comprises a first control circuit 402 that, during operation, is activated during the first state to provide the first control mode. As discussed previously, the first control mode may be a linear control mode, such as a current control mode.

The controller 300 further comprises a hysteretic control circuit 404 that, during operation, is activated during the second state to provide the hysteretic control.

A control circuit being “activated” simply means that the specific activated control circuit is managing the control of the switching converter 300. For example, “activated” may refer to the activated control circuit transitioning from an off state, where it receives no power, to an on state, where it is powered. Alternatively, “activated” may refer to the activated control circuit transitioning from a standby mode (where it does not manage the control of the switching converter 300) to an operational mode (where it manages the control of the switching converter 300), with the control circuit receiving power irrespective of whether it is operating in a standby or operational mode.

FIG. 4C is a schematic of the controller 300 in accordance with a fourth embodiment of the present disclosure, showing specific implementations of the control circuits 402, 404. It will be appreciated that the first control circuit 402 is illustrated as providing current mode control. However, in further embodiments, alternative control schemes may be provided by the first control circuit 402 in accordance with the understanding of the skilled person. In the present example, the switching converter 302 is a buck converter. However, in further embodiments, the switching converter 302 may be a different type of switching converter such as a boost converter, a buck-boost converter or a hybrid converter, in accordance with the understanding of the skilled person.

The buck converter 302 comprises power switches 406, 408, an inductor 410 (being the first energy storage element) and a capacitor 412.

The first control circuit 402 is configured to generate a digital target current signal DITARGET using the digitized output voltage signal DOUT. The first control circuit 402 comprises a voltage error generation circuit 414 configured to use the digitized output voltage signal DOUT and a digital voltage reference signal DREF to generate a digital error signal DVERR. The first control circuit 402 further comprises a digital target current signal generation circuit 416 configured to convert the digital error signal DVERR into the digital target current signal DITARGET.

The digital target current signal generation circuit 416 may comprise a proportional-integral (PI) circuit or a proportional-integral-derivate (PID) circuit. In the present embodiment, the circuit 416 comprises the PI circuit. In the present embodiment, the PI circuit 416 comprises amplifiers 418, 420; summing circuits 422, 424 and a register 426. The register 426 may alternatively be referred to as a memory element. It will be appreciated that a PI circuit, which has no derivative component, may still be referred to as “PID”, in accordance with the understanding of the skilled person.

The voltage error generation circuit 414 may be configured to generate the digital error signal DVERR by subtraction the digitized output voltage signal DOUT from the digital voltage reference signal DREF.

The first control circuit 402 may comprise a current error generation circuit 428 that is configured to receive the digital target current signal DITARGET and a digitized current signal DIL, then generate a digital current error signal DIERR. The digitized current signal DIL is a digital representation of a current flow through the first energy storage element, which in the present embodiment is the inductor 410.

The digitized current signal DIL may be received from a digitized current generation circuit 430. The digitized current generation circuit 430 may comprise an analog to digital converter than is configured to sense the current flow through the first energy storage element 410 and to digitize the sensed current flow to generate the digitized current signal DIL. The digitized current generation circuit 430 may, additionally or alternatively, comprise a current synthesizer for generation of the digitized current signal DIL.

The first control circuit 402 may comprise a modulator 432 that is configured to generate a first mode control signal MOD_MAG using the digital current error signal DIERR. The controller 300 may further comprise a logic and gate driver circuit 434 that is configured to receive the first mode control signal MOD_MAG during the first state, and to generate a gate driving signal GP, GN for each of the power switches 406, 408 using the first mode control signal MOD_MAG.

It will be appreciated that the present embodiment includes a buck converter having two power switches. Further embodiments may be provided having a different switching converter configuration and comprising fewer power switches or more power switches than the present embodiment.

The hysteretic control circuit 404 is configured to generate an up signal 436 for controlling the power switches 406, 408 to charge the first energy storage element 410 and a down signal 438 for controlling the power switches 406, 408 to discharge the first energy storage element 410. During operation, the up signal 436 is generated when the digitized output voltage DOUT falls below a first threshold voltage and the down signal 438 is generated when the digitized output voltage DOUT rises above a second threshold voltage.

The controller 300 may further comprise a logic and gate driver circuit 434 that is configured to receive the first mode control signal MOD_MAG, and to generate a gate driving signal GP, GN for each of the power switches 406, 408 using the first mode control signal MOD_MAG, during the first state.

The logic and gate driver circuit 434 is configured to receive the up signal 436 and the down signal 438 and to generate the gate driving signals GP, GN for each of the power switches 406, 408 using the up and down signals 436, 438, during the second state.

It will be appreciated that the present embodiment includes a buck converter having two power switches. Further embodiments may be provided having a different switching converter configuration and comprising fewer power switches or more power switches than the present embodiment.

The controller 300 may comprise one or more digital gates configured to receive the first mode control signal MOD_MAG, the up signal 436 and the down signal 438. During the first state, the one or more digital gates provide the first mode control signal MOD_MAG to the logic and gate drivers 434, and during the second state, the one or more digital gates provide the up and down signals 436, 438 to the logic and gate drivers 434.

In the present embodiment, the one or more digital gates comprises an AND gate 440 and an OR gate 442. The AND gate 440 comprises an inverted input 444 for receiving the down signal 438 and a non-inverting input 446 for receiving the first mode control signal MOD_MAG. The OR gate 442 comprises an input 448 for receiving the up signal 436 and an input 450 for receiving an output of the AND gate 440.

The OR gate 442 further comprises an output 452 for providing the first mode control signal MOD_MAG during the first state, and for providing the up and down signal 436, 438 during the second state.

In the present embodiment, the first control circuit 402 functions as described in FIG. 2A, where the first control circuit 402 functions as a PI linear loop that generates the digital target current DITARGET and has the modulator 432 generate the first mode control signal MOD_MAG to ensure that the inductor current IL is approximately equal to the digital target current DITARGET.

The hysteretic assistance loop is provided by the hysteretic control circuit 404. In response to a load transient, depending on whether the transient is rising or falling, the hysteretic control circuit 404 sets one of its outputs (labelled HYSTUP and HYSTDW) to 1, thereby providing the up and down signals 436, 438. This acts to override the first mode control signal MOD_MAG through the gates 440, 442. If there is no sudden load transient, the outputs HYSTUP, HYSTDW are zero and the modulator 432 drives the switching operation.

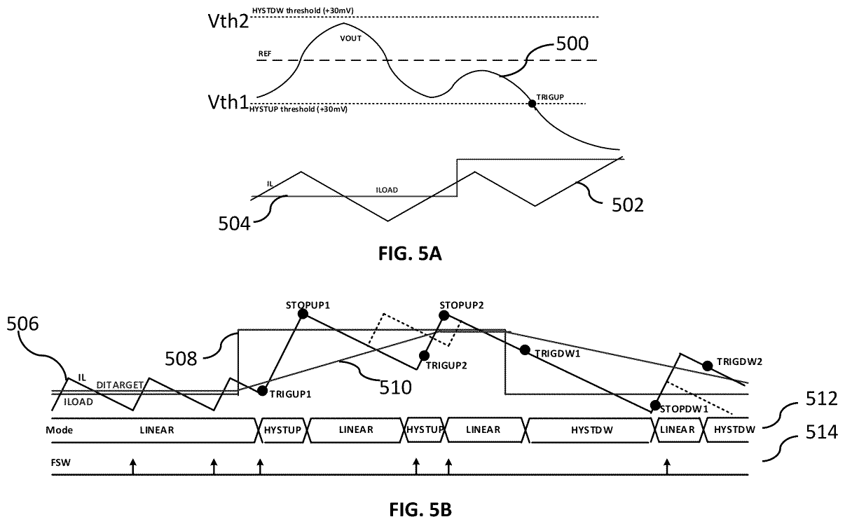

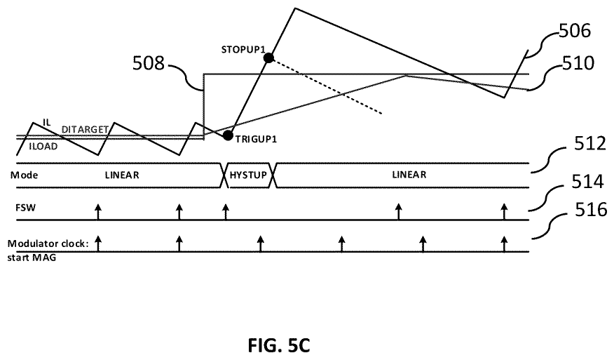

FIG. 5A is a timing graph showing waveforms relating to a practical implementation of the controller 300 and switching converter 302 of FIG. 4C. There is shown the output voltage of the switching converter 302 (a trace 500), a threshold voltage Vth1 and a threshold voltage Vth2. When the output voltage Vout falls below which the threshold voltage Vth1, the up signal 436 is generated; and when the output voltage Vout rises above the threshold voltage Vth2, the down signal 438 is generated.

There is also shown the inductor current IL (a trace 502) and a load current ILOAD (a trace 504). In the present embodiment, when the linear PI control 402 provides control of the switching converter 302, the hysteretic loop no longer sets the ripple. Ripple in the linear control mode may be up to +/−30 mV. Therefore, to prevent the hysteretic control circuit 404 from over-triggering, we would need to extend the thresholds for hysteretic triggering beyond the +/−5 mV of the hysteretic-only system as presented in FIG. 2B beyond +/−30 mV. This may be referred to as “oversizing the hysteretic limits”.

FIG. 5B is a further timing graph showing waveforms relating to a practical implementation of the controller 300 and the switching converter 302 of FIG. 4C. There is shown the inductor current IL (a trace 506), the load current ILOAD (a trace 508), the digital target current DITARGET (a trace 510), the control mode (labelled 512), and a charging pulse (a trace 514).

FIG. 5C is a further timing graph showing the waveforms as presented in FIG. 4C over a specific time period. Also shown is a clock signal (a trace 516) that is used to start the modulator 432.

With reference to FIG. 5A, if the load current ILOAD is stepped up while the control circuit 402 is providing control, the inductor current IL will not spontaneously react and it keeps ramping up then down (the linear PI is slow).

However, the output VOUT collapses and hysteretic control circuit 404 can charge the inductor 410 (at “TRIGUP”) when the inductor current IL is very low, as shown in the graph. As a consequence, the output voltage VOUT will drop further down until the inductor current IL has built up to the load current ILOAD.

Intuitively, we see that the output voltage VOUT can drop by half the 30 mV ripple, i.e. by a total of 60 mV, which is not desirable for a practical implementation of a hysteretic converter.

When the hysteretic control circuit 404 is controlling the switching converter 302, it takes control of the gate driving signals GP, GN regardless of the inductor current IL. Therefore, the inductor current IL will vary without feedback of the inductor current IL contributing to the control. Additionally, the control of the switches no longer follows a constant switching frequency FSW.

This results in two potential issues that can appear when leaving the hysteretic mode and going back to the linear mode, as shown in FIG. 5B.
1. Inductor current IL control continuity. When the load current ILOAD is stepped up, the hysteretic takes over (HYSTUP), but meanwhile, the PI regulation slowly increases DITARGET (which is not used anymore, because the hysteretic has taken over). At point STOPUP1, DITARGET has reached only e.g. 3A, while the hysteretic control already created 6 A. As now we are swapping back to the linear regulation, IL will suddenly be decreased from 6A to 3A because the linear regulation set it back to 3A. That will decrease the output voltage VOUT and trigger again hysteretic (TRIGUP2). The same toggling (which can even lead to sustained oscillations) holds for HYSTDW1,2.
2. Frequency continuity. In the FIG. 5C, at point STOPUP1, the DC/DC clock that e.g. starts magnetize can be anywhere (as shown by the trace 516). FIG. 5C demonstrates an undesirable sequence where a magnetizations is started right at STOPUP1 and the inductor 410 continues charging. While some modulators (like peak-current ones) will immediately stop the magnetization, other modulator types (for example the average current mode) may have an extra 50 ns magnetize time beyond STOPUP1 as is shown in FIG. 5C. The dotted lines indicate the desired performance at this point. The continued magnetization can induce “bouncing” on the output voltage VOUT, which can over-trigger e.g. HYSTDW (hysteretic to decrease VOUT) and result in sustained oscillations.

In a specific embodiment, the controller 300 is configured to sample the output voltage VOUT of the switching converter 302, at two time steps and then determine a sampled voltage difference by subtracting the initial sample from the later sample, as follows:

$$ΔV OUT = V OUT 2 - V OUT 1 \qquad ( 2 )$$

where ΔVOUT is the sampled voltage difference, VOUT2 is the second voltage sample and VOUT1 is the first voltage sample, where the second voltage sample VOUT2 is acquired after the first VOUT1.

The controller 300 is further configured to generate the up signal 436 for charging the first energy storage element 410 when the sampled voltage difference is less than a voltage difference threshold value VDIFFTH1, which may be represented as follows:

$$ΔV OUT < V DIFFTH 1 \qquad ( 3 )$$

The controller 300 may be further configured to generate the down signal 438 for discharging the first energy storage element 410 when the sampled voltage difference is greater than a voltage difference threshold value VDIFFTH2, which may be represented as follows:

$$ΔV OUT > V DIFFTH 2 \qquad ( 4 )$$

The sampled voltages VOUT1, VOUT2 may be acquired during different switching periods of the switching converter 302. In a specific embodiment the time step when the second voltage sample VOUT2 is acquired may be a single switching period after the first voltage sample VOUT1 was acquired.

The voltage sampling process may be repeated multiple times and may be repeated periodically.

In a general embodiment, the controller 300 is configured to periodically sample the output voltage VOUT to acquire n sampled voltages over n time steps, where n is an integer. The controller 300 repeatedly determines an nth sampled voltage difference ΔVOUT[n] by subtracting an (n-m)th sampled voltage VOUT[n−m] from the nth sampled voltage VOUT[n], where m is an integer, which may be represented as follows:

$$ΔV OUT [ n ] = V OUT [ n ] - V OUT [ n - m ] \qquad ( 5 )$$

The up signal 436 is generated for charging the first energy storage element 410 when the nth sampled voltage difference is less than the voltage difference threshold value VDIFFTH1, which may be represented as follows:

$$ΔV OUT [ n ] < V DIFFTH 1 \qquad ( 6 )$$

The down signal 438 is generated for discharging the first energy storage element 410 when the nth sampled voltage difference is greater than the voltage difference threshold value VDIFFTH2, which may be represented as follows:

$$ΔV OUT [ n ] > V DIFFTH 2 \qquad ( 7 )$$

The first voltage difference threshold value VDIFFTH1 may be the negative of the second voltage difference threshold value VDIFFTH2.

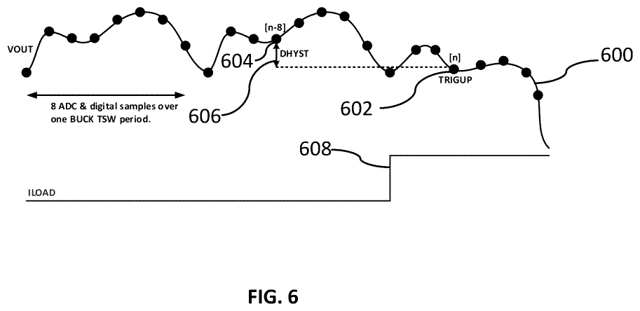

FIG. 6 is a timing graph relating to a practical implementation of the present embodiment of the controller 300. In the present example, and with reference to equation (4), m is equal to 8. There is shown the output voltage VOUT (a trace 600) a voltage sample VOUT[n] (a point 602) and a voltage sample VOUT[n−8] (a point 604). The voltage difference threshold value VDIFFTH1 is labelled with reference numeral 606. There is also shown the load current ILOAD (a trace 608).

Eight samples are acquired over a single switching period of the switching converter 302, with ΔVOUT[n] being calculated and evaluated in relation to the threshold values, with each sample acquisition.

By way of example, let us assume that VOUT[n] is 0.97V, VOUT[n−8] is 1V, and VDIFFTH1 is −15 mV. From equation (5), ΔVOUT[n]=−30 mV. In accordance with equation (6), as ΔVOUT[n]<VDIFFTH1, the up signal 436 is generated and the first energy storage element 410 is charged.

The output voltage VOUT can have any large magnitude and randomly-shaped ripple because the controller 300 can apply to multi-phases. In the present example, there are 8 digital sampling points per switching period TSW period that can be processed.

With reference to FIG. 6, the first two DCDC periods of the output voltage VOUT show a periodic behaviour. Then the load current ILOAD is stepped up and the following data points show the output voltage VOUT collapsing.

In the present example, there are 8 points per DCDC period and the controller 300 continuously compares VOUT[n] to VOUT[n−8] instead of just comparing the output voltage VOUT to a fixed threshold.

This condition allows the controller 300 to ignore the ripple, and it allows the triggering of the hysteretic when VOUT[n] has dropped by 15 mV compared to its previous VOUT[n−8] counterpart. Compared to having a constant −30 mV threshold (with the consequence shown in the FIG. 5A), it makes the hysteretic trigger much more reactive, even for large random ripple on voltage VOUT.

Using the above technique, where the output voltage VOUT is sampled to identify a sampled voltage difference, the issue of having to oversize the hysteretic limits (for example as shown in FIG. 5A) is resolved, as hysteretic entry is not based on fixed limits.

In further embodiments, other conditions may be added based on both output voltage VOUT history and output voltage VOUT levels and slopes.

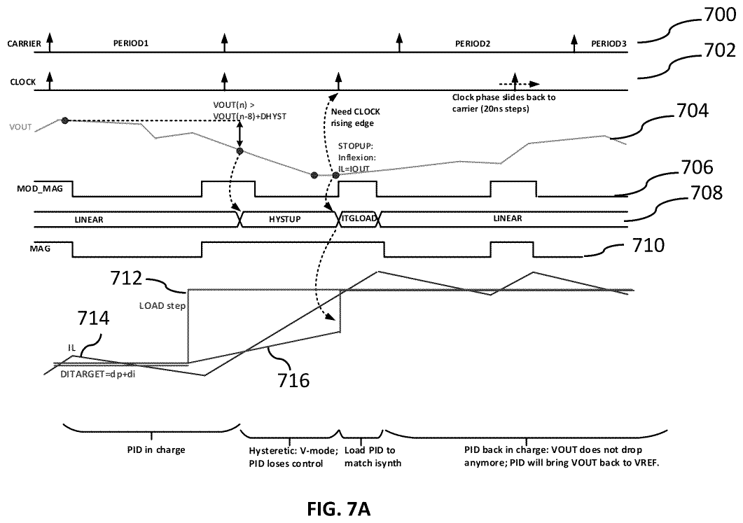

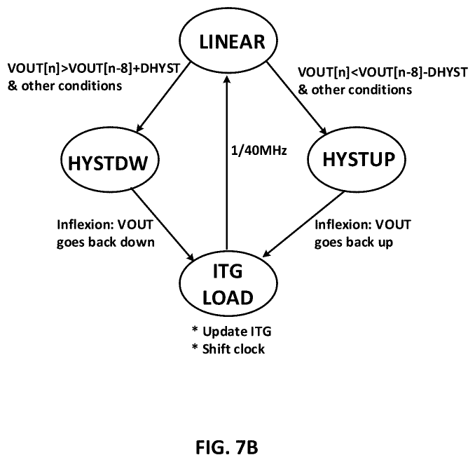

In a specific embodiment, the controller 300 is configured to control the switching converter 302 whilst operating in an intermediate control mode during a third state. FIG. 7A is a timing graph relating to a practical implementation of the present embodiment of the controller 300. There is shown: a carrier clock signal (a trace 700); a clock signal (a trace 702); the output voltage VOUT (a trace 704); the first control mode signal MOD_MAG (a trace 706); the control mode (labelled 708); the magnetization signal MAG provided to the logic and drivers 434 (a trace 710); the load current ILOAD (a trace 712); the inductor current IL (a trace 714); and the digital target current DITARGET (a trace 716).

In FIG. 7A, the control mode 708 is labelled “ITGLOAD” for the period of time over which the controller 300 is providing intermediate control mode control.

The controller 300 is configured to switch from the first control mode (in the present example the linear mode, and labelled LINEAR) to the hysteretic control mode (for example, labelled HYSTUP) in response to a load transient (labelled LOAD step). The controller 300 is configured to switch to the intermediate control mode after the hysteretic control mode and before switching to the first control mode.

In the present embodiment, the controller 300 is configured to correct the digital target current signal DITARGET during the intermediate control mode.

The amplifiers 418, 420 are configured to receive the digital error signal DVERR. The amplifier 418 comprises an output coupled to an input of summing circuit 422. The amplifier 420 comprises an output coupled to an input of the summing circuit 424. An output of the summing circuit 424 is coupled to an input of the summing circuit 422 and an input of the register 426. The register 426 comprises an output coupled to an input of the summing circuit 424. Note that the combination of the summing circuit 424 and the register 426 is a digital integrator, hence the naming DI for its output.

The controller 300 is configured to update the register 426 based on the digitized current signal DIL, the gain P of the amplifier 418, the digitized output voltage signal DOUT and the digital voltage reference signal DREF, thereby correcting the digital target current signal DITARGET during the intermediate control mode.

The controller 300 may further be configured to resynchronise a clock cycle of the switching converter 302 to the carrier clock after switching from the intermediate control mode. The is illustrated in FIG. 7A, where, after the switch from the intermediate control mode, the clock phase shown in trace 702 shifts closer to the carrier clock signal after having become desynchronised. We “slide” the clock so that it gets back in phase with a fixed carrier. This creates an advantage for EMI spectrum.

The carrier may be a constant reference frequency that the switching converter preferably aligns with, in phase. So, when there is a hysteretic event, the switching converter clock is no longer used. At the end of the hysteretic, it is re-started at will, but then we expect it will slide so that eventually it is in phase with the carrier (which does not change). For a large circuit with several switching converters (such as buck converters), we want to be in control of the phase for each switching converter. Each switching converter gets a carrier, and will lock its switching frequency with this carrier, at the exception of these sporadic hysteretic events.

The operation of the specific embodiment of the controller 300 as illustrated in FIG. 7A may be summarised as follows:
The controller 300 initially operates in the linear control mode, where the control circuit 402 provides PID control to generate the digital target current, which commands the average inductor current IL. The DCDC “clock” follows a carrier clock, which stays constant, as shown by the pulses of the traces 700, 702 being synchronised. The MAG signal (trace 710) is the same as the MOD_MAG signal (trace 706).
A load step then triggers a drop on the output voltage (trace 704) and based on the previously described sampling method for triggering entry into a hysteretic control mode, the controller 300 switches to the hysteretic control mode. The MAG signal (trace 710) is now forced by the hysteretic modulation and is no longer equal to the MOD_MAG signal (trace 706). The MAG signal is maintained until the output voltage VOUT stops drooping, which means that a sufficient inductor current IL has been built up to match the load current ILOAD. At this point, it is possible to exit the hysteretic mode.
In the present embodiment, there is provided the intermediate control mode ITGLOAD where the following two operations are undertaken:
   The digital target current DITARGET is adjusted, such that the digital target current DITARGET commands the inductor current IL, thereby resolving the issue of DITARGET being slow to ramp up, as discussed previously in relation to FIG. 5B. The digital target current DITARGET is corrected as if the PID circuit is commanding the effective inductor current, which can be written as follows:

$$DITARGET = DP + DI = P ( DREF - DOUT ) + DI \qquad ( 8 )$$

where, DP is the output of the amplifier 418, DI is the output of the summing circuit 424, P is the gain of the amplifier 418 and the other symbols have their meanings as previously described.

The digitized inductor current DIL must equal DITARGET, which can be written as follows:

$$DIL = P ( DREF - DOUT ) + DI \qquad ( 9 )$$

which may be rewritten as follows:

$$DI = DIL - P ( DREF - DOUT ) \qquad ( 10 )$$

In operation, the register 426 is loaded with the new value for the output DI using equation (10) and the digitized inductor current DIL.
The DCDC clock can be changed during the intermediate mode ITGLOAD, to avoid extending the magnetisation further, for example as occurs due to the clock mismatch as illustrated in FIG. 5C. In the present embodiment, the modulator 432 may be implemented as described in U.S. Ser. No. 18/361,274. In the present embodiment, a rising clock edge is used, and in further embodiments, any suitable clock phase may be used in accordance with the understanding of the skilled person.
Then, after these two ITG/CLOCK updates during the state ITGLOAD, the PID linear regulation takes over (denoted by LINEAR in the trace 708). It is now properly pre-set to avoid any magnetization periods that are too long or an incorrect DITARGET.
Additionally, the controller 300 is configured to “slowly slide” the edge of CLOCK (trace 702) during subsequent periods (PERIOD2, PERIOD3 . . . ) so that eventually it goes back in phase with the CARRIER (the trace 700). The advantage is that it becomes as if the CLOCK signal had constant frequency but had a jump in phase. This is thus phase modulation and not frequency modulation, and has consequences on the spectrum.

It will be appreciated, that the above process takes advantage of the following features of the specific embodiment of the digital controller 300:
The inductor current IL is digitized, for example according to U.S. Ser. No. 18/361,240. In the FIG. 5B, we see that at the point STOPUP1, IL can be much higher than the current commanded by the PID, and the clock of the modulator can be anywhere.
The clock is a digital signal; we can control the time at which it starts/stops with time steps from the system clock: for example, the DCDC clock can be 5 MHz, and the system clock can be 40 MHz. In this case the DCDC clock can be started/stopped whenever we want, with a resolution of 25 ns.

FIG. 7B is a flow chart showing the process undertaken by the specific embodiment of the controller 300 as described in relation to FIG. 7A.

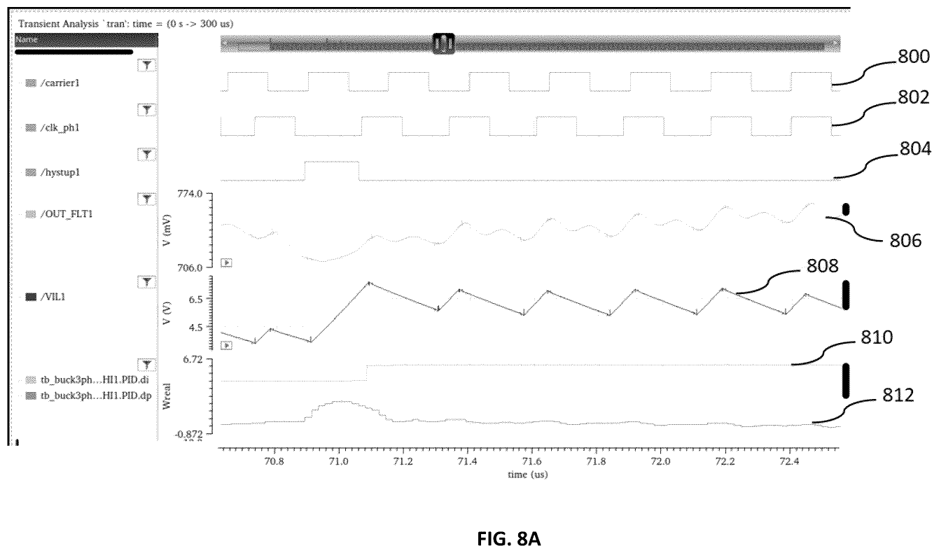

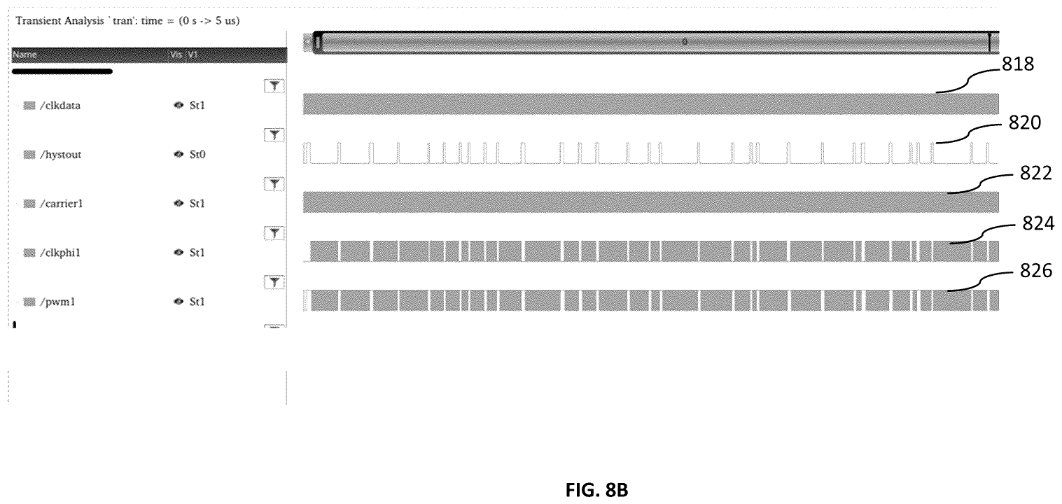

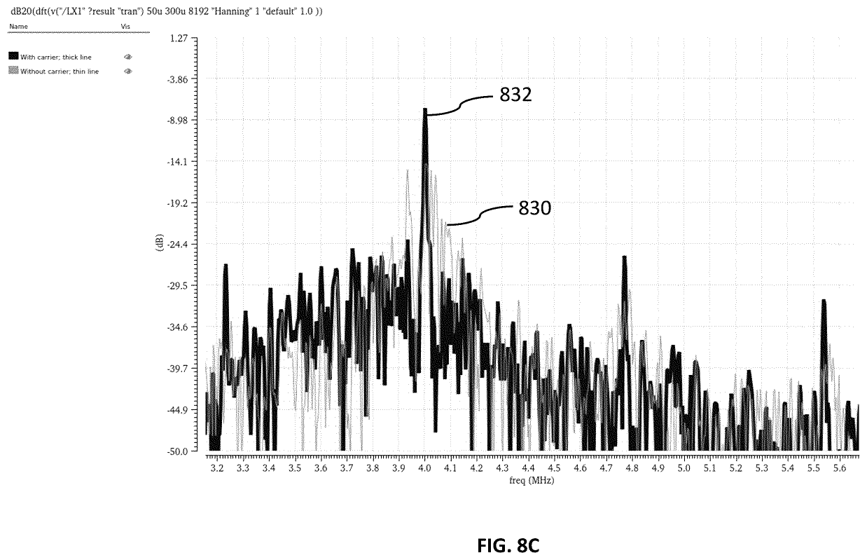

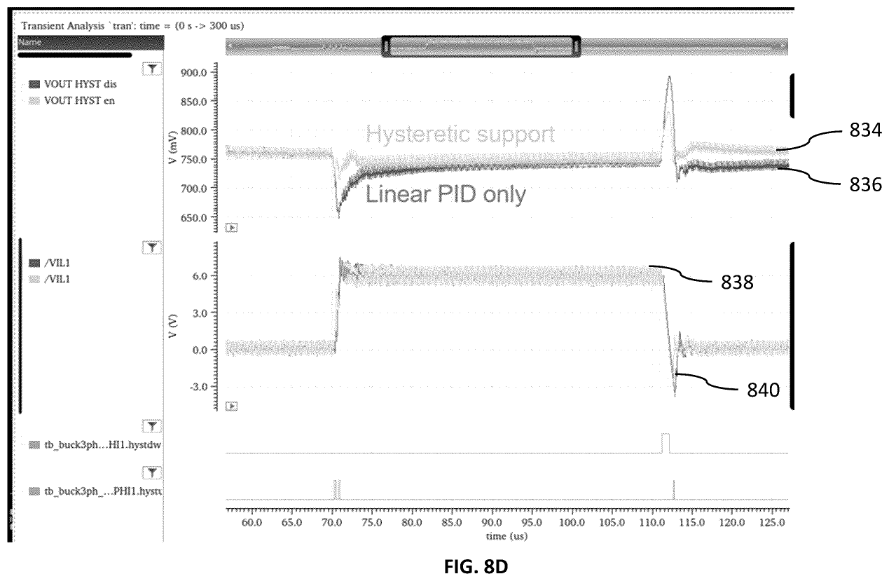

FIG. 8A shows simulation results of a practical implementation of the controller 300. There is shown: the carrier clock signal (a trace 800), the clock signal (a trace 802), a hysteretic up mode status signal (a trace 804), the output voltage (a trace 806), a sensed current voltage that is representative of the inductor current (a trace 808), output DI (a trace 810), output DP (a trace 812), and a trace 814 and a trace 816.

FIG. 8B shows simulation results of a practical implementation of the controller 300 showing random hysteretic events with clock sliding recovery. There is shown: a trace 818, a trace 820, a trace 822, a trace 824, a trace 826, a trace 828.
The trace 818 is the 40 MHz 1/Ts clock used for processing.
The trace 820 are the hysteretic events, either HYSTUP or HYSTDW, which allow the VOUT faster recovery.
The trace 822 is the constant carrier frequency: 4 MHz for example: it is the signal we will always try to synchronize FSW with.
The trace 824 is the effective DCDC clock. This overall picture shows this clock has discontinuities every time an hystout event is finishing because as described in the previous figure, this is our clock recovery scheme. Later after each hystout event, by the sliding scheme, 824 will slide back to be in phase with 822.
The trace 826: actual signal generated by the modulator and that drives the power switches. So, we also see it has discontinuity: constant ‘1’ for example whenever there is an hystout event.

An advantage of this clock scheme is that as the DCDC clock always shifts back to a fixed carrier, hysteretic events can be considered as phase disturbances and not frequency disturbances. As phase is the integral of frequency, it compresses the spectrum: if FSW is 4 MHZ, a standard hysteretic loop, even with PLL/FLL assistance, would create random jumps and spreads the spectrum without control around 4 MHz. This hysteretic scheme will tighten this spread around 4 MHz.

FIG. 8C shows simulation results of the practical implementation of the controller 300. There is shown a trace 830, a trace 832. There can be observed a 6 dB to 20 dB attenuation of spurious around the harmonics 4 MHz, 8 MHz.

The switching node SW in the FIGS. 1, 2A and 2B behaves like an antenna. The traces 830, 832 are the Fourier transform of this SW node captured over the simulation shown in FIG. 8B.

As the power stage is switching at 4 MHz for example, and then if the SW spectrum is tight over this 4 MHz, this means that the antenna is emitting, but is under control on a known frequency location.

The DCDC 4 MHz (usually this is marginal) may be slightly shifted in case it is close to a channel. For example, if close to a radio 3.9 MHz channel, then we shift the BUCK frequency to 4.2 MHz. Therefore, it is preferable having a tight spectrum.

FIG. 8D shows simulation results of a practical implementation of the controller 300 compared with a system that only provides linear control. There is shown the output voltage for a switching converter 302 using a specific embodiment of the controller 300 of the present disclosure (a trace 834) and the output voltage for a system using only linear mode control (a trace 836). There is also shown a load current (a trace 838) for an embodiment of the present disclosure, and a load current (a trace 840) for linear control only.

It can be observed that the controller 300 of the present disclosure provides a substantial improvement over a system using linear-only control.

In summary embodiments of the present disclosure may provide one or more of the following:
Combined digital linear control and digital hysteretic assistance that can be swapped on the fly. This applies to any current-mode digitally-controlled converter.
Transition to hysteretic based on VOUT history. An algorithm based on VOUT history and without the requirement for fixed thresholds. This is applicable to hysteretic controllers that are assistance-loops. In embodiments of the present disclosure, the hysteretic controller does not set the voltage ripple but instead rejects the ripple.
Swap from hysteretic back to linear using the DIL internal state value to update the integrator path or any other internal variable to ensure the linear regulation target is the actual DIL (and thus the actual inductor current) at the moment the linear loop is taking back control.
Swap from hysteretic back to linear: shift the clock edge to ensure the continuity of the modulation.
Sliding clock recovery to ensure phase modulation and not frequency modulation: it is preferable to reconnect to a fixed carrier.

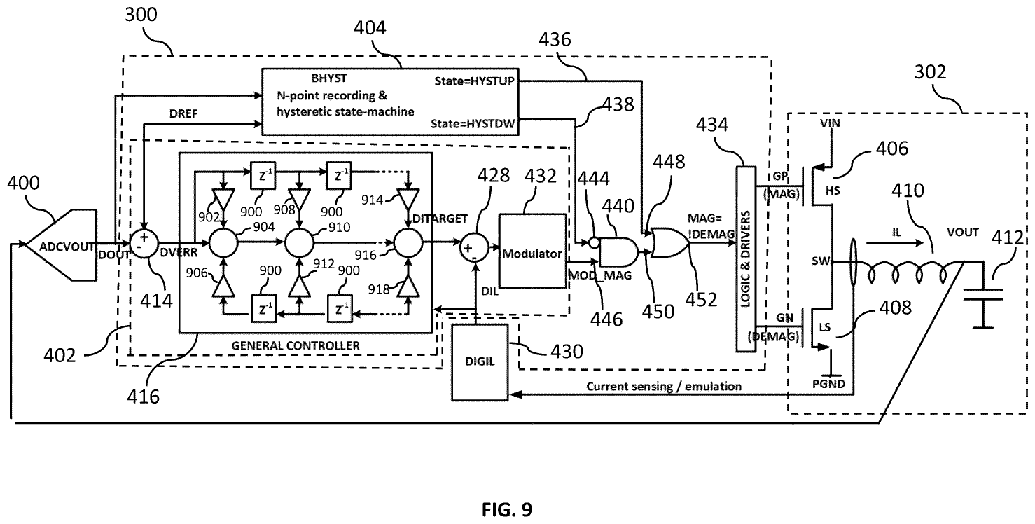

FIG. 9 is a schematic of the controller 300 in accordance with a fifth embodiment of the present disclosure. In the present embodiment, there is provided an alternative implementation of the digital target current signal generation circuit 416.

The digital target current signal generation circuit 416 may comprise one or more registers, with there being provided four registers 900 in the present embodiment. The registers 900 may be referred to as memory elements.

The controller 300 is configured to update at least one of the one or more of the registers 900 based on the digitized current signal DIL, thereby correcting the digital target current signal DITARGET during the intermediate control mode.

The digital target current signal generation circuit 416 may further comprise circuit components 902, 904, 906, 908, 910, 912, 914. 916, 918.

Various improvements and modifications can be made to the above without departing from the scope of the disclosure.

1. A controller for a switching converter, the switching converter being configured to receive an input voltage and to generate an output voltage, and comprising one or more power switches and one or more energy storage elements, the one or more energy storage elements comprising a first energy storage element, the controller being configured to:
control the switching converter whilst operating in a first control mode during a first state; and
control the switching converter whilst operating in a hysteretic control mode during a second state.

2. The controller of claim 1, wherein the controller is further configured to receive a digitized output voltage signal, the digitized output voltage signal being a digital representation of the output voltage of the switching converter.

3. The controller of claim 2, further comprising a first control circuit, the first control circuit being activated during the first state to provide the first control mode.

4. The controller of claim 3, wherein the first control circuit is configured to generate a digital target current signal using the digitized output voltage signal.

5. The controller of claim 4, wherein the first control circuit comprises:
a first voltage error generation circuit configured to use the digitized output voltage signal and a digital voltage reference signal to generate a digital error signal; and
a digital target current signal generation circuit configured to convert the digital error signal into the digital target current signal.

6. The controller of claim 2, further comprising a hysteretic control circuit, the hysteretic control circuit being activated during the second state to provide the hysteretic control mode.

7. The controller of claim 1, wherein the controller is further configured to switch from the first control mode to the hysteretic control mode in response to a load transient.

8. The controller of claim 7, wherein the controller is further configured to receive a digitized output voltage signal, the digitized output voltage signal being a digital representation of the output voltage of the switching converter.

9. The controller of claim 8, further comprising a first control circuit, the first control circuit being activated during the first state to provide the first control mode.

10. The controller of claim 9, wherein the first control circuit is configured to generate a digital target current signal using the digitized output voltage signal.

11. The controller of claim 10, wherein the first control circuit comprises a first current error generation circuit configured to:
receive the digital target current signal;
receive a digitized current signal, the digitized current signal being a digital representation of a current flow through the first energy storage element; and
generate a digital current error signal.

12. The controller of claim 6, wherein the controller is further configured to:
sample the output voltage to acquire a first sampled voltage at a first time step and a second sampled voltage at a second time step;
determine a sampled voltage difference by subtracting the second sampled voltage from the first sampled voltage;
generate an up signal for charging the first energy storage element during the second state when the sampled voltage difference is less than a first voltage difference threshold value; and
generate a down signal for discharging the first energy storage element during the second state when the sampled voltage difference is greater than a second voltage difference threshold value.

13. The controller of claim 12, wherein the first sampled voltage is acquired during a first switching period of the switching converter and the second sampled voltage is acquired during a second switching period of the switching converter.

14. The controller of claim 6, wherein the controller is further configured to:
periodically sample the output voltage to acquire n sampled voltages over n time steps, where n is an integer;
repeatedly determine an nth sampled voltage difference by subtracting an (n−m)th sampled voltage from the nth sampled voltage where m is an integer;
generate an up signal for charging the first energy storage element during the second state when the nth sampled voltage difference is less than a first voltage difference threshold value; and
generate a down signal for discharging the first energy storage element during the second state when the nth sampled voltage difference is greater than a second voltage difference threshold value.

15. The controller of claim 14, wherein the (n−m)th sampled voltage is acquired during a first switching period of the switching converter and the nth sampled voltage is acquired during a second period of the switching converter.

16. The controller of claim 1, wherein the controller is further configured to control the switching converter whilst operating in an intermediate control mode during a third state.

17. The controller of claim 16, wherein the controller is further configured to switch from the first control mode to the hysteretic control mode in response to a load transient.

18. The controller of claim 17, wherein the controller is further configured to switch to the intermediate control mode after the hysteretic control mode and before switching to the first control mode.

19. The controller of claim 18, wherein the controller is further configured to receive a digitized output voltage signal, the digitized output voltage signal being a digital representation of the output voltage of the switching converter.

20. The controller of claim 19, further comprising a first control circuit, the first control circuit being activated during the first state to provide the first control mode.

21. The controller of claim 20, wherein the first control circuit is configured to generate a digital target current signal using the digitized output voltage signal.

22. The controller of claim 21, wherein the first control circuit comprises:
a first voltage error generation circuit configured to use the digitized output voltage signal and a digital voltage reference signal to generate a digital error signal; and
a digital target current signal generation circuit configured to convert the digital error signal into the digital target current signal.

23. The controller of claim 22, wherein the controller is further configured to correct the digital target current signal during the intermediate control mode.

24. The controller of claim 23, wherein the digital target current signal generation circuit comprises one or more registers.

25. The controller of claim 24, wherein the controller is further configured to update at least one of the one or more registers based on the digitized current signal, thereby correcting the digital target current signal during the intermediate control mode.

26. The controller of claim 18, wherein the controller is further configured to resynchronize a clock cycle of the switching converter to a carrier clock after switching from the intermediate control mode.

27. A method of controlling a switching converter using a controller, the switching converter being configured to receive an input voltage and to generate an output voltage, and comprising one or more power switches and one or more energy storage elements, the one or more energy storage elements comprising a first energy storage element, the method comprising:
controlling the switching converter whilst operating in a first control mode during a first state; and
controlling the switching converter whilst operating in a hysteretic control mode during a second state.
